(19) United States
(12) Patent Application Publication
(10) Pub. No.: US 2018/0305184 A1
(43) Pub. Date: Oct. 25, 2018

(54) PASSENGER CONVEYOR STEP AND METHOD FOR ASSEMBLING PASSENGER CONVEYOR STEP

(71) Applicant: MITSUBISHI ELECTRIC CORPORATION, Chiyoda-ku, Tokyo (JP)

(72) Inventors: Hirokazu Nishida, Tokyo (JP); Shingo Doi, Tokyo (JP)

(73) Assignee: MITSUBISHI ELECTRIC CORPORATION, Chiyoda-ku, Tokyo (JP)

(21) Appl. No.: 15/764,159

(22) PCT Filed: Oct. 3, 2016
(86) PCT No.: PCT/JP2016/079334

§ 371 Date: Mar. 28, 2018

(30) Foreign Application Priority Data
Oct. 5, 2015 (JP) 2015-197413

(51) Int. Cl. B66B 23/12

(52) U.S. Cl. CPC B66B 23/12; B66B 23/024

(57) ABSTRACT

In the step for a passenger conveyor, a sleeve includes a sleeve main body, which has a tubular shape and is slidable with respect to a main shaft portion along an axis line of the step shaft, a claw to be hooked to a level-difference portion formed at a boundary between the main shaft portion and a projecting shaft portion, and a connecting portion configured to connect the sleeve main body and the claw. The connecting portion includes an arm portion which is elastically deformable in a direction in which the claw is unhooked from the level-difference portion. A mounting portion, having a recessed portion formed therein, is fixed to the step main body. The recessed portion is fitted over an outer peripheral surface of the sleeve main body. An open portion of the recessed portion is smaller than an outer diameter of the sleeve main body.

### TECHNICAL FIELD

The present invention relates to a step for a passenger conveyor, which includes a step main body mounted to a step shaft through intermediation of sleeves, and a method of assembling a step for a passenger conveyor.

### BACKGROUND ART

Hitherto, there is known a step for a passenger conveyor, which includes a step shaft having large-diameter portions and small-diameter portions formed thereon and a step main body mounted to the step shaft through intermediation of sleeves respectively fitted over the small-diameter portions. In the related-art step for a passenger conveyor described above, each of the sleeves is brought into contact with a level-difference portion formed at a boundary between the small-diameter portion and the large-diameter portion to position the sleeve with respect to the step shaft, to thereby position the step main body in an axis-line direction of the step shaft. The step main body is mounted to the sleeves by fitting grooves formed in a lower surface of the step main body over outer peripheral surfaces of the sleeves, bringing fixing plates into contact with the outer peripheral surfaces of the sleeves from underneath the step main body, and fastening the fixing plates to the lower surface of the step main body with a plurality of screws (see, for example, Patent Literature 1).

Further, hitherto, there is also known a step for a passenger conveyor, which includes a step shaft having a circumferential groove formed therein and a sleeve having a protrusion formed on an inner peripheral surface. The protrusion of the sleeve is fitted into the groove of the step shaft to position the sleeve with respect to the step shaft. A cross-sectional shape of the sleeve is a C-like shape. In the related-art step for a passenger conveyor, the sleeve is fitted over the step shaft by widening an opening portion of the sleeve having the C-like shape while elastically deforming the sleeve to insert the step shaft into the sleeve through the opening portion of the sleeve having the C-like shape. A step main body is mounted to the sleeve by fastening a fixing plate to the step main body with screws while interposing the sleeve between the step main body and the fixing plate (see, for example, Patent Literature 2).

Further, hitherto, there is also known a step for a passenger conveyor, in which sleeves are mounted to a step shaft in a slidable manner and clamps arranged on both sides of the sleeves in an axis line thereof are mounted to the step shaft so as to position the sleeves with respect to the step shaft (see, for example, Patent Literature 3).

### CITATION LIST

### Patent Literature

[PTL 1] JP 61-189075 U

[PTL 2] JP 2000-344455 A

[PTL 3] JP 2006-27751 A

### SUMMARY OF INVENTION

### Technical Problem

In the related-art steps for a passenger conveyor which are disclosed in Patent Literatures 1 and 2, however, the fixing plates and the screws for mounting the step main body to the sleeves are required. Therefore, not only the number of components increases, but also work for mounting the step main body to the sleeves takes time and effort.

Further, in the related-art step for a passenger conveyor which is disclosed in Patent Literature 3, the clamps which are dedicated components for positioning the sleeves are mounted to the step shaft. Therefore, the number of components increases, and work for positioning the sleeves takes time and effort.

The present invention has been made to solve the problem described above, and has an object to provide a step for a passenger conveyor, which enables simplification of a configuration and alleviation of a burden of work for mounting a step main body to a step shaft through intermediation of sleeves, and a method of assembling the step for a passenger conveyor.

### Solution to Problem

According to the present invention, there is provided a step for a passenger conveyor, including a step shaft; a sleeve provided to the step shaft; and a step main body provided to the sleeve, in which the step shaft includes a main shaft portion and a projecting shaft portion, which has an outer diameter smaller than an outer diameter of the main shaft portion and projects from an end portion of the main shaft portion, in which the sleeve includes: a sleeve main body, which has a cylindrical shape and is slidable with respect to the main shaft portion along an axis line of the step shaft; a claw to be hooked to a level-difference portion formed at a boundary between the main shaft portion and the projecting shaft portion; and a connecting portion configured to connect the sleeve main body and the claw, in which a mounting portion is fixed to the step main body, the mounting portion having a recessed portion formed therein, in which the recessed portion is fitted over an outer peripheral surface of the sleeve main body, in which the recessed portion has an open portion smaller than an outer diameter of the sleeve main body, and in which the connecting portion includes an arm portion which is elastically deformable in a direction in which the claw is unhooked from the level-difference portion.

### Advantageous Effects of Invention

With the step for a passenger conveyor and the method of assembling the step for a passenger conveyor according to the present invention, only by hooking the claws to the level-difference portions, the sleeve can be easily positioned in an axis-line direction of the step shaft with respect to the step shaft. Further, the mounting portion can be easily mounted to the sleeve and can be prevented from being disengaged from the sleeve even without a mounting fixing plate to the step main body with screws as otherwise required in the related art. As a result, the configuration of the step can be simplified, while the burden of work for mounting the step main body to the step shaft through intermediation of the sleeve can be alleviated.

### BRIEF DESCRIPTION OF DRAWINGS

FIG. 1 is a side view for illustrating an escalator which is a passenger conveyor of a first embodiment of the present invention.

FIG. 2 is a schematic partial sectional view for illustrating a step illustrated in FIG. 1.

FIG. 3 is a sectional view taken along the line III-III in FIG. 2.

FIG. 4 is a perspective view for illustrating a sleeve illustrated in FIG. 2.

FIG. 5 is a side view for illustrating a state in which a main shaft portion illustrated in FIG. 3 is disengaged from a recessed portion.

FIG. 6 is a side view for illustrating a state in which the main shaft portion illustrated in FIG. 5 is inserted in the recessed portion.

FIG. 7 is a partial sectional view for illustrating a state in which the sleeve illustrated in FIG. 2 is disengaged from the recessed portion.

FIG. 8 is a perspective view for illustrating another example of the sleeve for the step for an escalator according to the first embodiment of the present invention.

FIG. 9 is a partial sectional view for illustrating the step for an escalator according to a second embodiment of the present invention.

FIG. 10 is a sectional view taken along the line X-X in FIG. 9.

FIG. 11 is a partial sectional view for illustrating the step for an escalator according to a third embodiment of the present invention.

FIG. 12 is a partial sectional view for illustrating the step for an escalator according to a fourth embodiment of the present invention.

FIG. 13 is a sectional view taken along the line XIII-XIII in FIG. 12.

FIG. 14 is a perspective view for illustrating the sleeve illustrated in FIG. 12.

FIG. 15 is a perspective view for illustrating a collar illustrated in FIG. 12.

FIG. 16 is a partial sectional view for illustrating a state in which a position of the collar illustrated in FIG. 12 is apart from a retaining position.

FIG. 17 is a partial sectional view for illustrating the step for an escalator according to a fifth embodiment of the present invention.

FIG. 18 is a sectional view taken along the line XVIII-XVIII in FIG. 17.

FIG. 19 is a partial sectional view for illustrating a state in which the sleeve illustrated in FIG. 17 is disengaged from the recessed portion.

### DESCRIPTION OF EMBODIMENTS

### First Embodiment

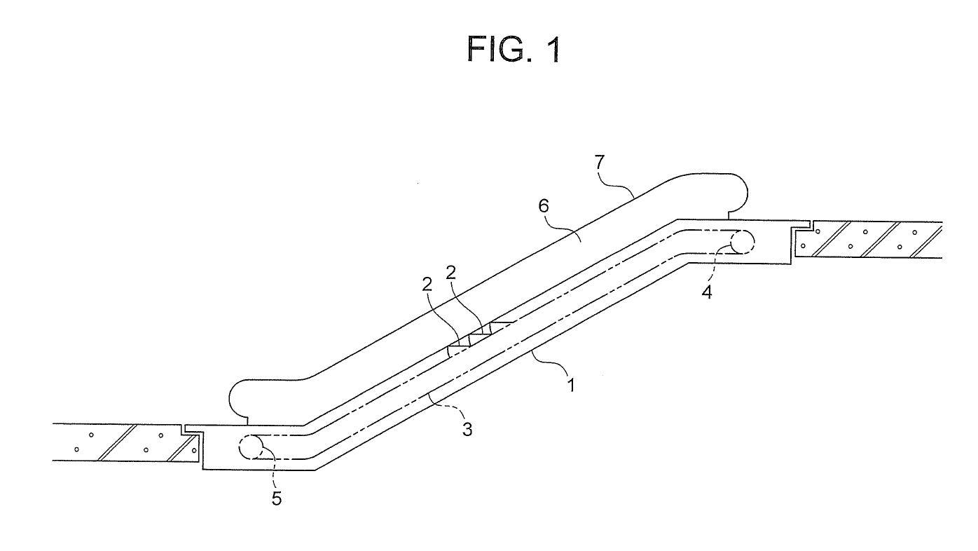

FIG. 1 is a side view for illustrating an escalator which is a passenger conveyor of a first embodiment of the present invention. In FIG. 1, a plurality of steps 2 are supported on a truss 1. The plurality of steps 2 are coupled in an endless manner by a pair of endless step chains 3 arranged on both sides of the steps 2 in a width direction of the steps 2.

A pair of upper sprockets 4 are provided in an upper machine room which is positioned at one longitudinal end portion of the truss 1. A pair of lower sprockets 5 are provided in a lower machine room which is positioned at another longitudinal end portion of the truss 1. The pair of upper sprockets 4 are arranged so as to be away from each other in a width direction of the truss 1, whereas the pair of lower sprockets 5 are also arranged so as to be away from each other in the width direction of the truss 1. The pair of upper sprockets 4 are rotated integrally about an upper sprocket shaft along the width direction of the truss 1 as a center. The pair of lower sprockets 5 are rotated integrally about a lower sprocket shaft along the width direction of the truss 1 as a center.

Of the pair of step chains 3, one step chain 3 is caused to pass over one upper sprocket 4 and one lower sprocket 5, whereas another step chain 3 is caused to pass over another upper sprocket 4 and another lower sprocket 5.

The pair of upper sprockets 4 are rotated integrally by a driving force of a driving machine (not shown) installed in the upper machine room. Guide rails (not shown) configured to guide the steps 2 are mounted to the truss 1. The plurality of steps 2 are moved to circulate between the one longitudinal end portion and the another longitudinal end portion of the truss 1 while being guided by the guide rails through the integral rotation of the pair of upper sprockets 4.

A pair of balustrades 6, which are opposed to each other in the width direction of the truss 1, are provided on the truss 1. An endless moving handrail 7 is provided to a peripheral edge portion of each of the balustrades 6. Each of the moving handrails 7 travels around each of the balustrades 6 in synchronization with the steps 2 by the driving force of the driving machine.

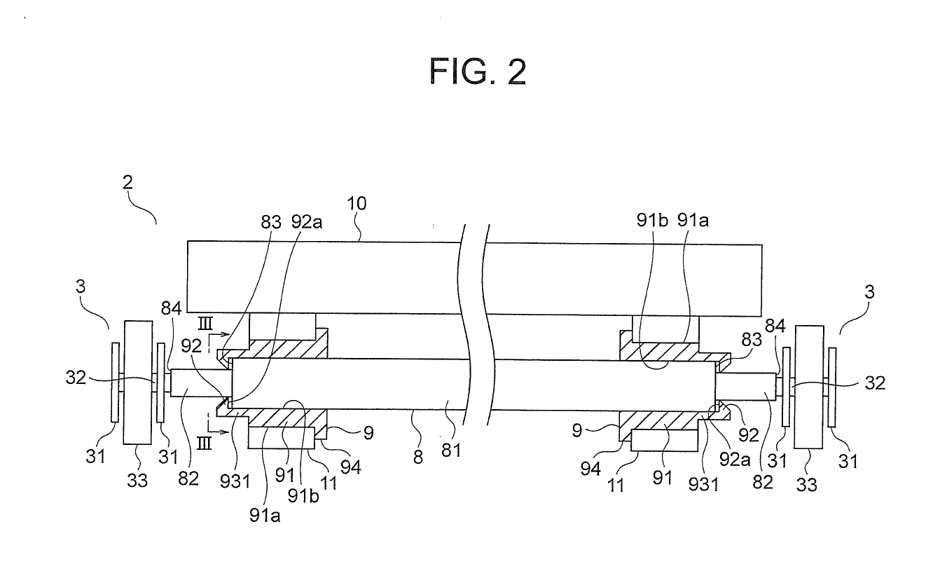

FIG. 2 is a schematic partial sectional view for illustrating the step 2 illustrated in FIG. 1. Further, FIG. 3 is a sectional view taken along the line III-III in FIG. 2. The step 2 includes a step shaft 8 arranged along the width direction of the truss 1, sleeves 9 provided to the step shaft 8, and a step main body 10 provided to the sleeves 9.

The step shaft 8 includes a main shaft portion 81 and a pair of projecting shaft portions 82 respectively projecting outward from both end portions of the main shaft portion 81 in an axis-line direction of the main shaft portion 81. Each of the main shaft portion 81 and the pair of projecting shaft portions 82 has a circular cross-sectional shape. Further, the main shaft portion 81 and the pair of projecting shaft portions 82 are arranged coaxially with an axis line of the step shaft 8.

An outer diameter of each of the projecting shaft portions 82 is smaller than an outer diameter of the main shaft portion 81. As a result, a first level-difference portion 83 is formed at a boundary between each of the pair of projecting shaft portions 82 and the main shaft portion 81. The first level-difference portion 83 is formed over the entire periphery of the step shaft 8 along a circumferential direction of the step shaft 8.

The pair of step chains 3 include a plurality of link plates 31 arrayed in a length direction of the step chains 3, a plurality of chain shafts 32, each being configured to couple the link plates 31 adjacent to each other in a freely rotatable manner, and a plurality of chain rollers 33 provided respectively to the chain shafts 32 in a freely rotatable manner.

The chain shaft 32 of the one step chain 3 is fixed to an end surface of one projecting shaft portion 82. The chain shaft 32 of the another step chain 3 is fixed to an end surface of another projecting shaft portion 82. The chain shaft 32 fixed to each of the projecting shaft portions 82 is arranged coaxially with the axis line of the step shaft 8. Further, an outer diameter of the chain shaft 32 is smaller than the outer diameter of the projecting shaft portion 82. As a result, a second level-difference portion 84 is formed at a boundary between the projecting shaft portion 82 and the chain shaft 32. The second level-difference portion 84 is formed over the entire periphery of the step shaft 8 along the circumferential direction of the step shaft 8. In this example, the step shaft 8 and the chain shaft 32 are formed as a single member which is formed integrally without combining a plurality of members.

The chain rollers 33 are rolled on the guide rails (not shown) mounted to the truss 1. By rolling the chain rollers 33 on the guide rails, the steps 2 are guided by the guide rails.

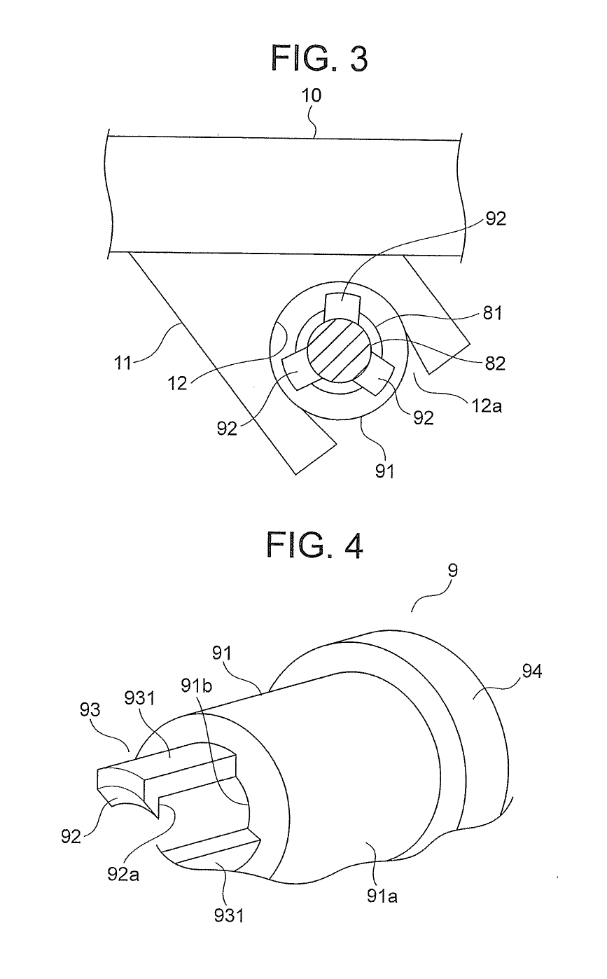

FIG. 4 is a perspective view for illustrating the sleeve 9 illustrated in FIG. 2. The sleeve 9 is mounted to the step shaft 8 in a freely rotatable manner. Further, the sleeve 9 includes a sleeve main body 91 having a cylindrical shape, a plurality of claws 92 to be hooked to the first level-difference portion 83, connecting portions 93 which respectively connect the sleeve main body 91 and the plurality of claws 92, and a flange portion 94 projecting radially outward from an outer peripheral surface 91a of the sleeve main body 91. In this example, the sleeve 9 is made of a resin. Further, in this example, the sleeve 9 is formed as a single member.

Inside the sleeve main body 91, the main shaft portion 81 is caused to pass therethrough. The sleeve main body 91 is slidable in the axis-line direction of the step shaft 8 with respect to the main shaft portion 81 under a state in which the sleeve main body 91 is fitted over an outer peripheral surface of the main shaft portion 81. Further, the sleeve main body 91 is freely rotatable in the circumferential direction of the step shaft 8 with respect to the main shaft portion 81 while an inner peripheral surface 91b of the sleeve main body 91 is being held in contact with the outer peripheral surface of the main shaft portion 81. A radial thickness of the sleeve main body 91 is equal to or larger than a radial thickness of each of the claws 92 and a radial thickness of each of the connecting portions 93.

The connecting portions 93 have a plurality of arm portions 931 which individually connect the claws 92 to the sleeve main body 91. In this example, three claws 92 are connected to the sleeve main body 91 through intermediation of three arm portions 931. Each of the arm portions 931 is elastically deformable in a direction in which each of the claws 92 is unhooked from the first level-difference portion 83. Specifically, each of the arm portions 931 is elastically deformable in a direction in which each of the claws 92 is displaced radially outward. Further, the arm portions 931 are arranged at intervals in a circumferential direction of the sleeve 9. In this example, the arm portions 931 are arranged at equal intervals in the circumferential direction of the sleeve 9. Further, in this example, a circumferential width of each of the arm portions 931 is equal to a circumferential width of each of the claws 92.

An engaging surface 92a of each of the claws 92 for the first level-difference portion 83 is orthogonal to an inner peripheral surface of each of the arm portions 931. As a result, under a state in which the claws 92 are hooked to the first level-difference portion 83, the arm portions 931 are arranged along the axis-line direction of the main shaft portion 81 so that the engaging surface 92a of each of the claws 92 is orthogonal to the axis line of the step shaft 8. Under the state in which the claws 92 are hooked to the first level-difference portion 83, inward displacement of each of the sleeves 9 in the axis-line direction of the main shaft portion 81 with respect to the step shaft 8 is inhibited.

The flange portion 94 is provided to an end portion of the sleeve main body 91, which is on a side opposite to an end portion to which the connecting portions 93 are provided, in an axis-line direction of the sleeve 9. In this example, the flange portion 94 is provided over the entire periphery of the sleeve main body 91. The flange portion 94 may be provided to only a part of the outer peripheral surface 91a of the sleeve main body 91 in a circumferential direction of the sleeve main body 91.

A pair of mounting portions 11 are fixed to the step main body 10 as illustrated in FIG. 2 and FIG. 3. The pair of mounting portions 11 are arranged so as to be away from each other in a width direction of the step main body 10. The mounting portions 11 are mounted to the sleeves 9, respectively.

A recessed portion 12 is formed in each of the mounting portions 11. The recessed portion 12 is a groove along the width direction of the step main body 10. A shape of an inner surface of the recessed portion 12 as viewed along the width direction of the step main body 10 is a circular shape in accordance with the outer peripheral surface 91a of the sleeve main body 91. The outer peripheral surface 91a of the sleeve main body 91 is fitted into the inner surface of the recessed portion 12. The mounting portion 11 is mounted to the sleeve 9 under a state in which the inner surface of the recessed portion 12 is fitted over the outer peripheral surface 91a of the sleeve main body 91.

An open portion 12a of the recessed portion 12 is smaller than an outer diameter of the sleeve main body 91. In this manner, the mounting portion 11 is prevented from being disengaged from the sleeve 9 through the open portion 12a of the recessed portion 12. Further, the open portion 12a of the recessed portion 12 is larger than the outer diameter of the main shaft portion 81 of the step shaft 8.

An inner diameter of the recessed portion 12 is smaller than an outer diameter of the flange portion 94. The flange portion 94 of the sleeve 9 is held in abutment against a side surface of each of the mounting portions 11. In this manner, outward displacement of each of the sleeves 9 in the axis-line direction of the main shaft portion 81 with respect to the step shaft 8 is inhibited. Specifically, in the step 2, the claws 92 are hooked to the first level-difference portion 83, while the flange portion abuts against the mounting portion 11. As a result, the displacement of the sleeve 9 with respect to the step shaft 8 is inhibited in the axis-line direction of the step shaft 8 so that the sleeve 9 is positioned in the axis-line direction of the step shaft 8.

Next, a procedure of assembling the step 2 is described. For assembling the step 2, the pair of sleeves 9 are mounted to the step shaft 8 in advance. For mounting the pair of sleeves 9 to the step shaft 8, after the inner peripheral surface of each of the sleeve main bodies 91 is fitted over the outer peripheral surface of the main shaft portion 81 from the projecting shaft portion 82 side, the sleeves 9 are fitted over the main shaft portion 81 while the arm portions 931 are elastically deformed to move the claws 92 radially outward so that the claws 92 are not caught by the first level-difference portions 83. As a result, the claws 92 are held in contact with the outer peripheral surface of the main shaft portion 81 by an elastic restoring force of each of the arm portions 931. Under this state, the pair of sleeves 9 are slidable in the axis-line direction of the step shaft 8 with respect to the main shaft portion 81 while the claws 92 are being held in contact with the outer peripheral surface of the main shaft portion 81. The pair of sleeves 9 fitted over the main shaft portion 81 are then slid inward in the axis-line direction of the step shaft 8 (sleeve mounting step).

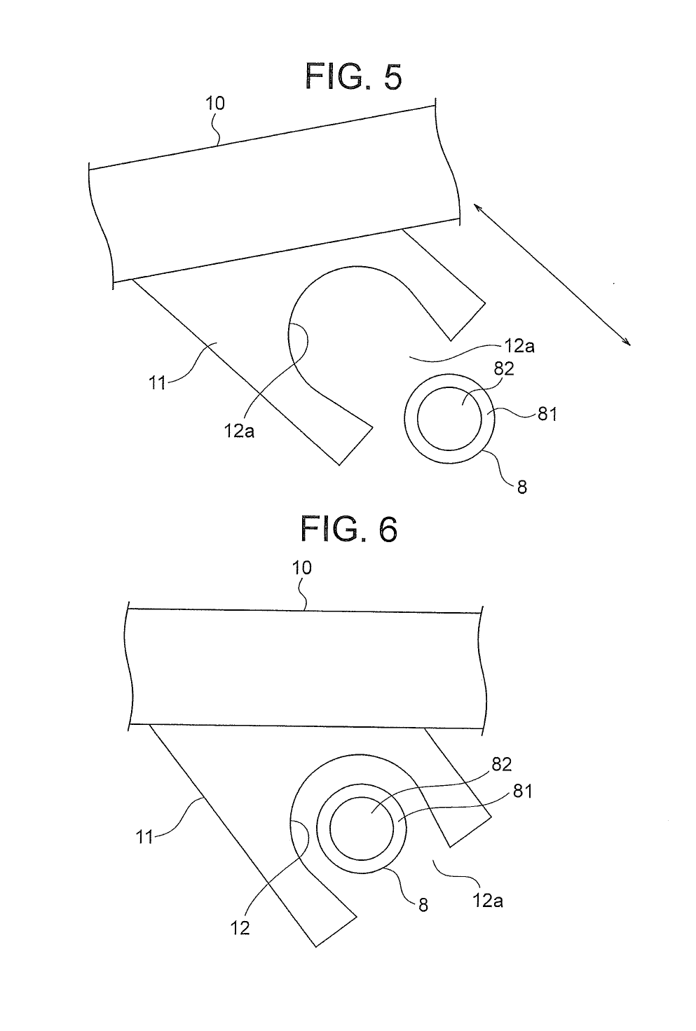

FIG. 5 is a side view for illustrating a state in which the main shaft portion 81 illustrated in FIG. 3 is disengaged from the recessed portion 12. FIG. 6 is a side view for illustrating a state in which the main shaft portion 81 illustrated in FIG. 5 is inserted in the recessed portion 12. The open portion 12a of the recessed portion 12 is larger than the outer diameter of the main shaft portion 81. Therefore, a portion of the main shaft portion 81 which is not present at the position of the sleeve 9 can be inserted in the recessed portion 12 through the open portion 12a of the recessed portion 12 as illustrated in FIG. 5 and FIG. 6.

After the sleeve mounting step, the main shaft portion 81 is inserted in the recessed portion 12 through the open portion 12a of the recessed portion 12 at a position different from a position of the sleeve 9 while the step main body 10 is being held, as illustrated in FIG. 5 and FIG. 6. Then, a position of the step main body 10 is kept under a state in which the main shaft portion 81 is inserted in the recessed portion 12. At this time, the main shaft portion 81 is arranged in the recessed portion 12 so that a clearance between the inner surface of the recessed portion 12 and the outer peripheral surface of the main shaft portion 81 becomes equal in the circumferential direction of the step shaft 8 (step-main-body arranging step).

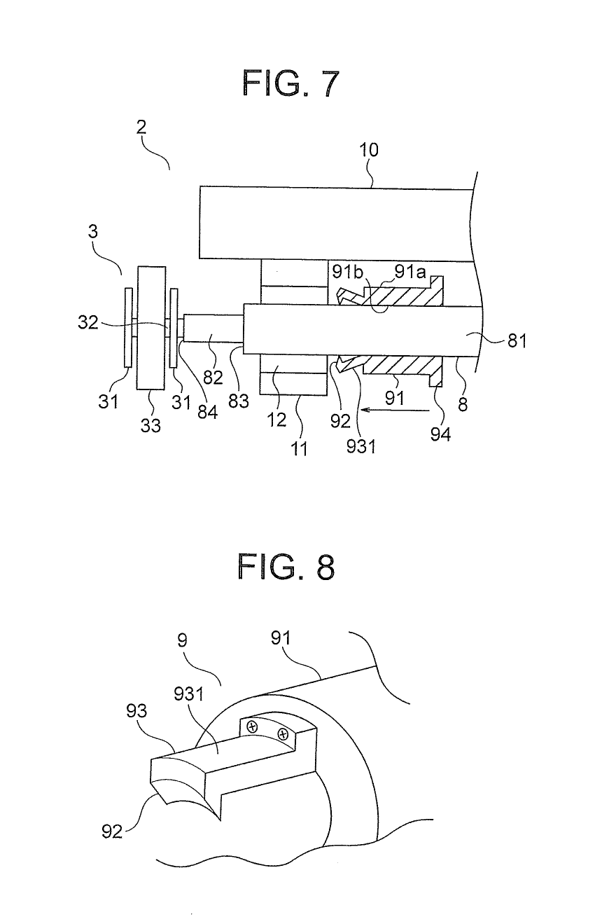

FIG. 7 is a partial sectional view for illustrating a state in which the sleeve 9 illustrated in FIG. 2 is disengaged from the recessed portion 12. After the step-main-body arranging step, the sleeve 9 is slid outward in the axis-line direction of the step shaft 8 with respect to the main shaft portion 81 under a state in which the main shaft portion 81 is inserted in the recessed portion 12. As a result, the claws 92 and the connecting portions 93 pass through the clearance between the inner surface of the recessed portion 12 and the outer peripheral surface of the main shaft portion 81 to fit the outer peripheral surface 91a of the sleeve main body 91 into the inner surface of the recessed portion 12. Thereafter, the sleeve main body 91 is further pushed into the recessed portion 12 while the sleeve 9 is being slid with respect to the main shaft portion 81. As a result, the claws 92 reach the first level-difference portion 83. After the claws 92 reach the first level-difference portion 83, the claws 92 are hooked to the first level-difference portion 83 by the elastic restoring force of each of the arm portions 931, while the flange portion 94 abuts against the side surface of the mounting portion 11. As a result, the step main body 10 is mounted to the step shaft 8 through intermediation of the sleeves 9. Hence, the step main body 10 is positioned in the axis-line direction of the step shaft 8 with respect to the step shaft 8 (step-main-body mounting step). In this manner, the step 2 is assembled.

For removing the step main body 10 from the step shaft 8, the claws 92 are unhooked from the first level-difference portions 83 while elastically deforming the arm portions 931 so as to slide the sleeves 9 inward in the axis-line direction of the main shaft portion 81. In this manner, the sleeves 9 are disengaged from the recessed portions 12 so that the mounting portions 11 are removed from the main shaft portion 81 through the open portions 12a of the recessed portions 12.

In the step 2 for an escalator described above, each of the sleeves 9 includes the sleeve main body 91 which is slidable with respect to the main shaft portion 81 of the step shaft 8, the claws 92 hooked to the first level-difference portion 83 of the step shaft 8, and the connecting portions 93 which connect the sleeve main body 91 and the claws 92. Therefore, only by hooking the claws 92 to the first level-difference portions 83, the sleeves 9 can be easily positioned in the axis-line direction of the step shaft 8 with respect to the step shaft 8. Further, the mounting portions 11 are fixed to the step main body 10. The inner surfaces of the recessed portions 12 respectively formed in the mounting portions 11 are fitted over the outer peripheral surfaces of the sleeve main bodies 91. The open portion 12a of each of the recessed portions 12 is smaller than the outer diameter of the sleeve main body 91. Therefore, the mounting portions 11 can be prevented from being disengaged from the sleeves 9 even without mounting fixing plates to the step main body 10 with screws as otherwise required in the related art. In this manner, the number of components of the step 2 can be reduced, and work for mounting the fixing plates to the step main body 10 with the screws can be eliminated. Based on the above-mentioned facts, a configuration of the step 2 can be simplified, while a burden of the work for mounting the step main body 10 to the step shaft 8 through intermediation of the sleeves 9 can be eased.

Further, the radial thickness of the sleeve main body 91 is equal to or larger than the radial thickness of each of the claws 92 and the radial thickness of each of the connecting portions 93. Therefore, when the sleeves 9 are slid under a state in which the main shaft portion 81 of the step shaft 8 is arranged in the recessed portions 12 of the mounting portions 11, the claws 92 and the arm portions 931 can be easily caused to pass through the clearances between the inner surfaces of the recessed portions 12 and the outer peripheral surface of the main shaft portion 81, respectively. As a result, the outer peripheral surface of the sleeve main body 91 can be easily fitted into the inner surface of the recessed portion 12. Thus, the work for mounting the step main body 10 to the step shaft 8 through intermediation of the sleeves 9 can be further facilitated.

Further, with the method of assembling the step 2 described above, under a state in which the main shaft portion 81 of the step shaft 8 is inserted in the recessed portions 12 of the mounting portions 11, the sleeves 9 are slid in the axis-line direction of the step shaft 8 with respect to the main shaft portion 81 to fit the outer peripheral surfaces of the sleeve main bodies 91 into the inner surfaces of the recessed portions 12, while the claws 92 are hooked to the first level-difference portions 83. Therefore, only by sliding the sleeves 9 with respect to the main shaft portion 81, the step main body 10 can be mounted to the step shaft 8 through intermediation of the sleeves 9. At the same time, the sleeves 9 can be positioned in the axis-line direction of the step shaft 8 with respect to the step shaft 8. As a result, the burden of the work for mounting the step main body 10 to the step shaft 8 through intermediation of the sleeves 9 can be alleviated. Further, the fixing plates are not required to be mounted to the step main body 10 with the screws as otherwise required in the related art. Thus, the number of components can be reduced, and hence the configuration of the step 2 can be simplified.

In the example described above, the sleeve 9 is formed as a single member. However, the sleeve 9 may be constructed by combining a plurality of members. For example, as illustrated in FIG. 8, a first member obtained by integrating the sleeve main body 91 and the flange portion 94 and second members, each obtained by integrating the claw 92 and the arm portion 931, may be formed as separate members. By fixing the second members to the first member with screws or other members, the sleeve 9 may be constructed. In this case, a material for forming the first member and a material for forming the second member can be different types of materials. For example, the first member may be formed of a resin, whereas the second member may be formed of a metal.

### Second Embodiment

In the first embodiment, the outer diameter of the projecting shaft portion 82 is larger than the outer diameter of the chain shaft 32. However, the outer diameter of the projecting shaft portion 82 maybe set equal to the outer diameter of the chain shaft 32 so that the projecting shaft portion 82 fulfills the functions of the chain shaft 32.

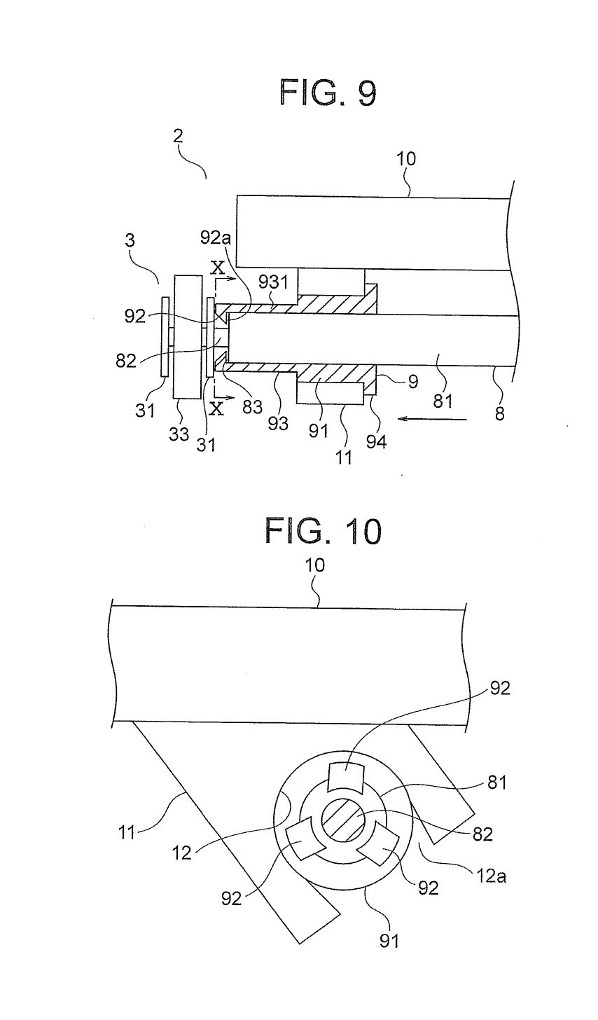

Specifically, FIG. 9 is a partial sectional view for illustrating the step for an escalator according to a second embodiment of the present invention. FIG. 10 is a sectional view taken along the line X-X in FIG. 9. The projecting shaft portion 82 fulfills the functions of the chain shaft 32 of the step chain 3. Specifically, the projecting shaft portion 82 couples the link plates 31 of the step chain 3, which are adjacent to each other, to each other in a freely rotatable manner. There exists a clearance between an end surface of the main shaft portion 81 and the link plate 31 of the step chain 3, in which the claws 92 can be inserted. An outer peripheral surface of the projecting shaft portion 82 has no level-difference portion formed thereon. The remaining configuration and method of assembling the step 2 are the same as those of the first embodiment.

In the step 2 for an escalator described above, the projecting shaft portion 82 of the step shaft 8 fulfills the functions of the chain shaft 32 of the step chain 3. Therefore, the second level-difference portion 84 formed at the boundary between the chain shaft 32 and the projecting shaft portion 82 as in the first embodiment can be eliminated. In this manner, manufacture of the step shaft 8 can be facilitated to reduce manufacturing cost of the step shaft 8.

### Third Embodiment

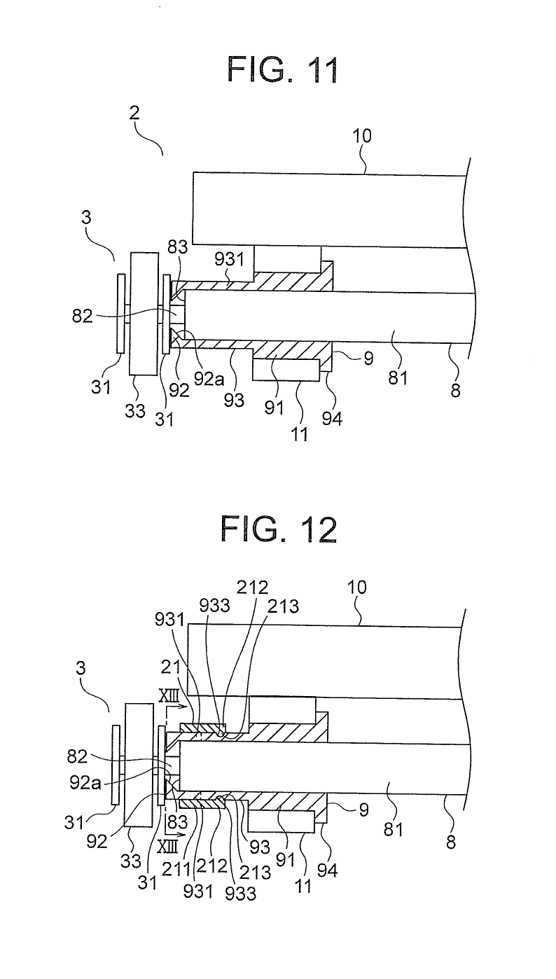

FIG. 11 is a partial sectional view for illustrating the step for an escalator according to a third embodiment of the present invention. The engaging surface 92a of each of the claws 92 for the first level-difference portion 83 is inclined with respect to the inner peripheral surface of the arm portion 931. Under a state in which the claws 92 are hooked to the first level-difference portion 83, the engaging surface 92a of the claw 92 for the first level-difference portion 83 is inclined with respect to the axis line of the step shaft 8, and hence a distance between the engaging surface 92a of the claw 92 and the outer peripheral surface of the projecting shaft portion 82 continuously decreases in a direction away from the arm portion 931. In this manner, when the sleeve 9 is slid inward in the axis-line direction of the step shaft 8 with respect to the step shaft 8 under a state in which the claws 92 are hooked to the first level-difference portion 83, positions of the claws 92 are moved radially outward while the engaging surfaces 92a of the claws 92 are being guided by the first level-difference portion 83 due to the inclination of the engaging surfaces 92a of the claws 92. As a result, the claws 92 are unhooked from the first level-difference portion 83. The remaining configuration and method of assembling the step 2 are the same as those of the second embodiment.

Next, a procedure of assembling the step 2 is described. For assembling the step 2, the pair of sleeves 9 are mounted to the step shaft 8 in advance as in the first embodiment.

For mounting the pair of sleeves 9 to the step shaft 8, after each of the inner peripheral surfaces of the sleeve main bodies 91 is fitted over the outer peripheral surface of the main shaft portion 81 from the projecting shaft portion 82 side as in the first embodiment, the sleeves 9 are pushed inward in the axis-line direction of the main shaft portion 81. As a result, the arm portions 931 are elastically deformed while the engaging surfaces 92a of the claws 92 are being guided by the first level-difference portions 83 to move the positions of the claws 92 radially outward, thereby fitting the sleeves 9 over the main shaft portion 81. The pair of sleeves 9 fitted over the main shaft portion 81 are then slid inward in the axis-line direction of the step shaft 8 (sleeve mounting step).

Thereafter, as in the first embodiment, the step-main-body arranging step and the step-main-body mounting step are carried out in the stated order so that the step main body 10 is mounted to the step shaft 8 through intermediation of the sleeves 9. In this manner, the step 2 is assembled.

For removing the step main body 10 from the step shaft 8, the sleeves 9 are slid inward in the axis-line direction of the main shaft portion 81. At this time, the engaging surfaces 92a of the claws 92 are guided by the first level-difference portions 83 to spontaneously move the positions of the claws 92 radially outward while the arm portions 931 are being elastically deformed. As a result, the claws 92 are unhooked from the first level-difference portions 83. Thereafter, the sleeves 9 are further slid inward in the axis-line direction of the main shaft portion 81 to disengage the sleeves 9 from the recessed portions 12 to remove the mounting portions 11 from the main shaft portion 81 through the open portions 12a of the recessed portions 12.

In the step 2 for an escalator described above, under the state in which the claws 92 are hooked to each of the first level-difference portions 83, the distance between the engaging surfaces 92a of the claws 92 for the first level-difference portion 83 and the outer peripheral surface of the projecting shaft portion 82 continuously decreases in the direction away from the arm portions 931. Therefore, only by sliding the sleeves 9 in the axis-line direction of the step shaft 8 with respect to the step shaft 8, the positions of the claws 92 can be moved radially outward while the engaging surfaces 92a are being guided by the first level-difference portions 83. In this manner, when the sleeves 9 are slid with respect to the step shaft 8, the claws 92 are spontaneously unhooked from the first level-difference portions 83. Therefore, the claws 92 can be easily unhooked from the first level-difference portions 83.

In the example described above, the configuration in which the engaging surfaces 92a of the claws 92 are inclined with respect to the inner peripheral surfaces of the arm portions 931 is applied to each of the sleeves 9 of the second embodiment. However, the configuration in which the engaging surfaces 92a of the claws 92 are inclined with respect to the inner peripheral surfaces of the arm portions 931 may be applied to each of the sleeves 9 of the first embodiment.

### Fourth Embodiment

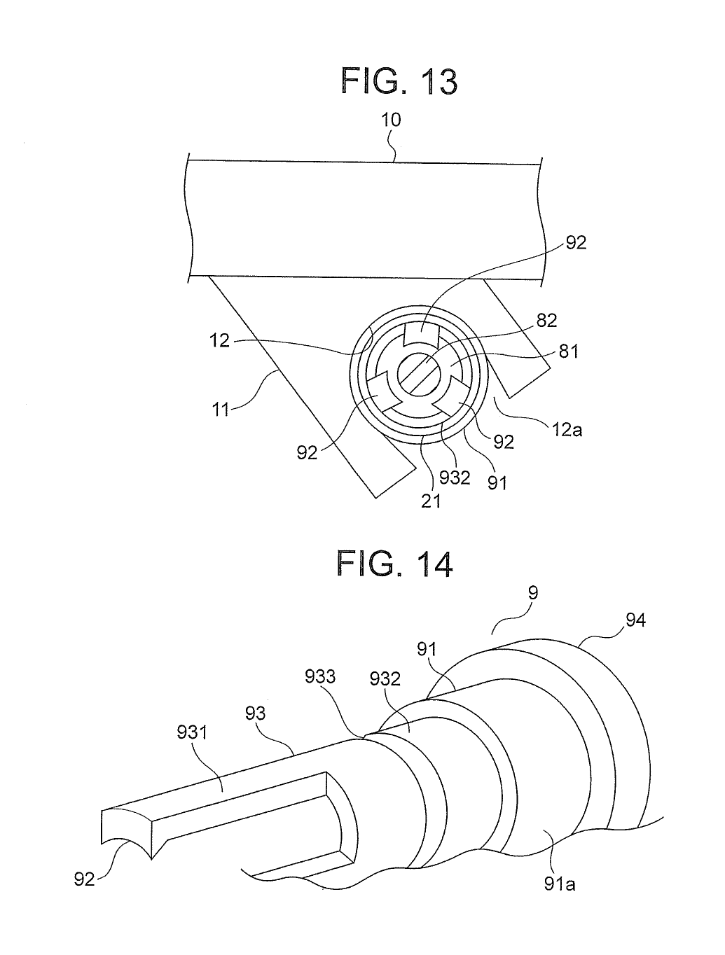

FIG. 12 is a partial sectional view for illustrating the step for an escalator according to a fourth embodiment of the present invention. FIG. 13 is a sectional view taken along the line XIII-XIII in FIG. 12. The step 2 further includes a collar 21 configured to surround the main shaft portion 81 of the step shaft 8 and the connecting portion 93 of the sleeve 9 in a collective manner. The collar 21 is fitted over an outer peripheral surface of the connecting portion 93.

FIG. 14 is a perspective view for illustrating the sleeve 9 illustrated in FIG. 12. The connecting portion 93 includes a tubular portion 932 projecting from the sleeve main body 91 and the plurality of arm portions 931 which individually connect the tubular portion 932 and the plurality of claws 92. A radial thickness of the tubular portion 932 is equal to a radial thickness of each of the arm portions 931.

The tubular portion 932 is arranged coaxially with the sleeve main body 91. Further, an inner diameter of the tubular portion 932 is equal to an inner diameter of the sleeve main body 91. Further, the radial thickness of the tubular portion 932 is smaller than the radial thickness of the sleeve main body 91. Therefore, an outer dimeter of the tubular portion 932 is smaller than the outer diameter of the sleeve main body 91.

Each of the arm portions 931 is arranged along the axis line of the step shaft 8. Further, each of the arm portions 931 is elastically deformable in a direction in which the claw 92 is unhooked from the first level-difference portion 83. Specifically, each of the arm portions 931 is elastically deformable in a direction in which the claw 92 is displaced radially outward. Further, the arm portions 931 are arranged at intervals in the circumferential direction of the sleeve 9. In this example, the arm portions 931 are arranged at equal intervals in the circumferential direction of the sleeve 9. Further, in this example, the circumferential width of each of the arm portions 931 is equal to the circumferential width of each of the claws 92.

A positioning groove 933 being a recessed portion is formed in an outer peripheral surface of the tubular portion 932. The positioning groove 933 is formed over the entire periphery of the tubular portion 932 along the circumferential direction of the sleeve 9.

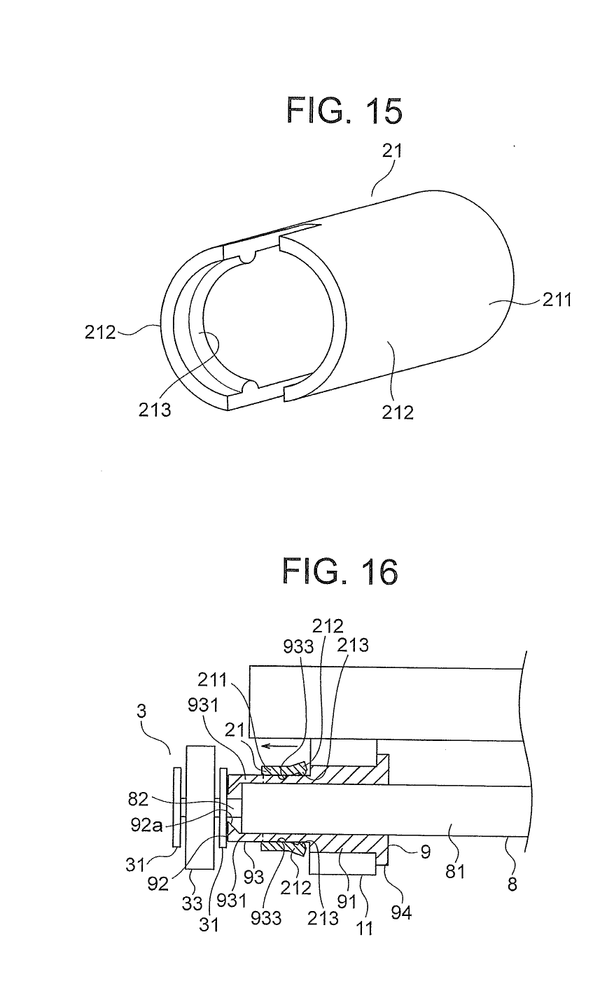

FIG. 15 is a perspective view for illustrating the collar 21 illustrated in FIG. 12. The collar 21 includes a collar main body 211 having a cylindrical shape, a plurality of collar projecting portions 212 projecting from the collar main body 211 along the connecting portion 93, and protrusions 213 respectively formed on inner peripheral surfaces of the collar projecting portions 212. In this example, the collar 21 is formed as a single member made of a resin.

The collar projecting portions 212 are arranged so as to be away from each other in a circumferential direction of the collar 21. Further, each of the collar projecting portions 212 is elastically deformable in a radial direction of the collar 21. Further, a cross-sectional shape of each of the collar projecting portions 212 is an arc-like shape along a circumferential direction of the collar main body 211. In this example, two collar projecting portions 212 project from an end portion of the collar main body 211.

The protrusions 213 are arranged along the circumferential direction of the collar 21. Further, the protrusions 213 are fitted into the positioning groove 933 of the tubular portion 932. A position of the collar 21 is maintained in a retaining position at which the protrusions 213 are fitted into the positioning groove 933 so that the collar main body 211 surrounds the outer peripheral surfaces of the arm portions 931 to retain the arm portions 931 with the collar main body 211. When the collar 21 is positioned at the retaining position, the radially outward elastic deformation of the arm portions 931 is inhibited by the collar main body 211 to prevent the claws 92 from being unhooked from the first level-difference portion 83.

FIG. 16 is a partial sectional view for illustrating a state in which the position of the collar 21 illustrated in FIG. 12 is apart from the retaining position. In the collar 21, the protrusions 213 can be disengaged from the positioning groove 933 by the radially outward elastic deformation of the collar projecting portions 212. Under a state in which the protrusions 213 are disengaged from the positioning groove 933, the collar 21 is slidable over the outer peripheral surface of the connecting portion 93 in the axis-line direction of the sleeve 9 between the retaining position (FIG. 12) at which the arm portions 931 are retained by the collar main body 211 and a release position (FIG. 16) at which the collar main body 211 is moved from the arm portions 931 to the tubular portion 932 to release the retention of the arm portions 931. When the collar 21 is positioned at the release position, the collar main body 211 is present at a position of the tubular portion 932. Therefore, the arm portions 931 are elastically deformable in a direction in which the claws 92 are unhooked from the first level-difference portion 83. The remaining configuration is the same as that of the third embodiment.

Next, a procedure of assembling the step 2 is described. For assembling the step 2, as in the third embodiment, the pair of sleeves 9 are mounted to the step shaft 8 in advance. Further, the collar 21 is fitted over each of the sleeves 9 in advance under a state in which the collar 21 is located at the release position with respect to the connecting portion 93. The pair of sleeves 9 fitted over the main shaft portion 81 are slid inward in the axis-line direction of the step shaft 8 (sleeve mounting step).

Thereafter, as in the first embodiment, the step-main-body arranging step and the step-main-body mounting step are carried out in the stated order to mount the step main body 10 to the step shaft 8 through intermediation of the sleeves 9. At this time, in the step-main-body mounting step, while the sleeves 9 are being slid with respect to the main shaft portion 81, the claws 92, the connecting portion 93, and the collar 21 are caused to pass through the clearance between the inner surface of the recessed portion 12 and the outer peripheral surface of the main shaft portion 81 to fit the outer peripheral surface of the sleeve main body 91 into the inner surface of the recessed portion 12.

Thereafter, as illustrated in FIG. 16, the collar 21 located at the release position is slid to the retaining position with respect to the connecting portion 93 to fit the protrusions 213 into the positioning groove 933. In this manner, the arm portions 931 are retained by the collar main body 211 to prevent the claws 92 from being unhooked from the first level-difference portion 83. In this manner, the step 2 is assembled.

For removing the step main body 10 from the step shaft 8, after the protrusions 213 are disengaged from the positioning groove 93, the collar 21 is slid from the retaining position to the release position with respect to the connecting portion 93. Thereafter, as in the third embodiment, the sleeves 9 are slid inward in the axis-line direction of the main shaft portion 81 to disengage the sleeves 9 from the recessed portions 12 so as to remove the mounting portions 11 from the main shaft portion 81 through the open portions 12a of the recessed portions 12.

In the step 2 for an escalator described above, the collar 21 is slidable over the outer peripheral surface of the connecting portion 93 between the retaining position at which the arm portions 931 are retained by the collar main body 211 and the release position at which the collar main body 211 is moved from the arm portions 931 to release the retention of the arm portions 931. The positioning groove 933 is formed in the outer peripheral surface of the connecting portion 93. When the collar 21 is located at the retaining position, the protrusions 213 are fitted into the positioning groove 933. Thus, by sliding the collar 21 to the retaining position, the arm portions 931 can be retained by the collar main body 211. Thus, during normal time, the claws 92 can be less liable to be unhooked from the first level-difference portion 83. As a result, the elastic restoring force of each of the arm portions 931 is not required to be increased. Thus, a structure of each of the arm portions 931 can be simplified.

In the example described above, the connecting portion 93 includes the tubular portion 932. However, the tubular portion 932 may be eliminated as in the third embodiment. In this case, the claws 92 are connected individually to the sleeve main body 91 through intermediation of the plurality of arm portions 931. Further, the positioning groove 933 being the recessed portion is formed in the outer peripheral surface of each of the arm portions 931.

In the example described above, the number of collar projecting portions 212 of the collar 21 is two. However, the number of collar projecting portions 212 may be one or three or more.

In the example described above, the positioning groove 933 along the circumferential direction of the collar 21 is formed in the outer peripheral surface of the connecting portion 93 as the recessed portion. However, the recessed portion is not required to be a groove. For example, a hole may be formed in the outer peripheral surface of the connecting portion 93 as the recessed portion.

Further, the collar 21 of the fourth embodiment may be applied to the sleeve 9 of the first embodiment or the second embodiment.

### Fifth Embodiment

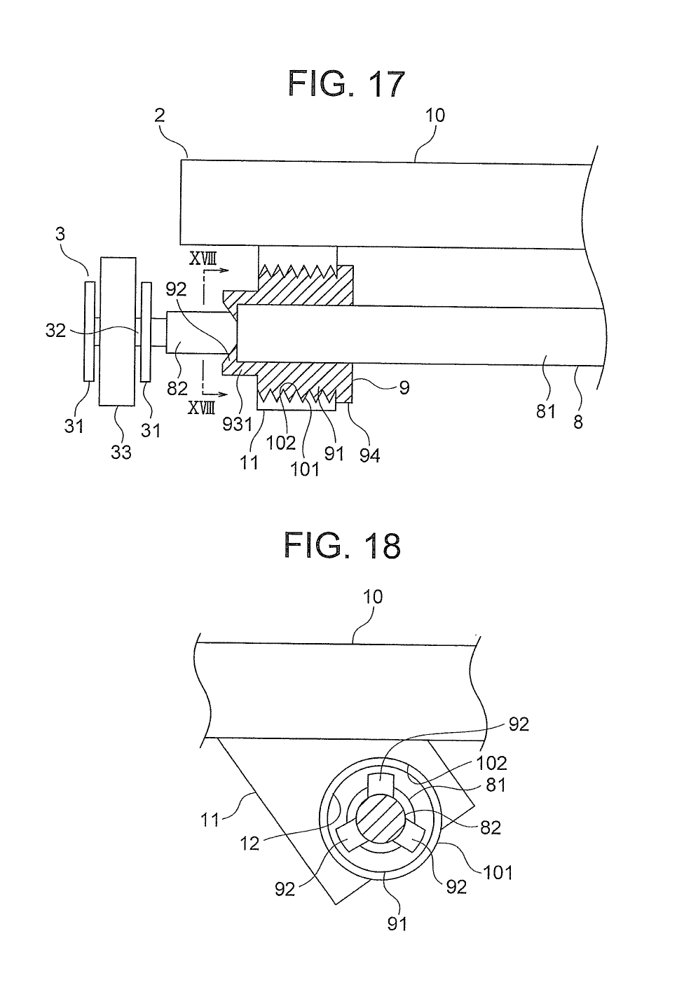

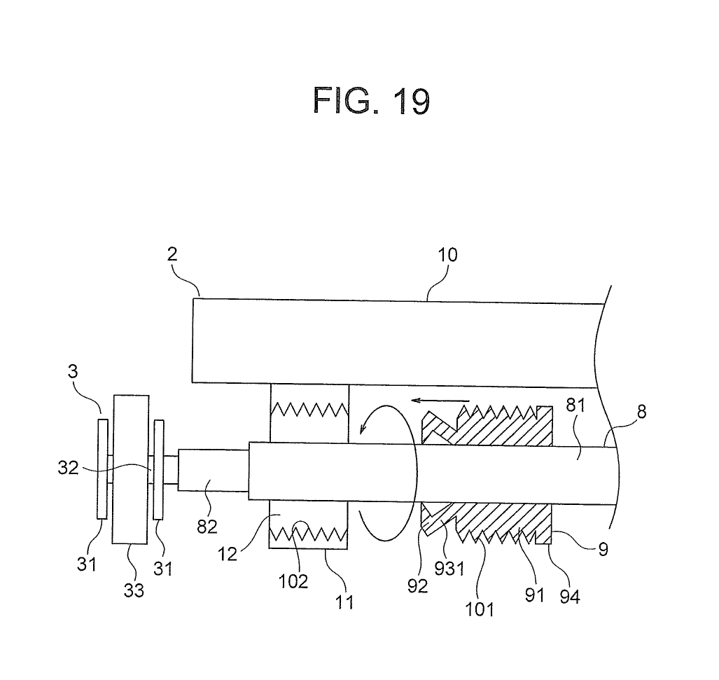

FIG. 17 is a partial sectional view for illustrating the step for an escalator according to a fifth embodiment of the present invention. FIG. 18 is a sectional view taken along the line XVIII-XVIII in FIG. 17. Further, FIG. 19 is a partial sectional view for illustrating a state in which the sleeve 9 illustrated in FIG. 17 is disengaged from the recessed portion 12. A male thread portion 101 is formed on the outer peripheral surface of the sleeve main body 91. A female thread portion 102 to be fitted to the male thread portion 101 is formed in an inner peripheral surface of the recessed portion 12 of the mounting portion 11. The recessed portion 12 of the mounting portion 11 is fitted over the outer peripheral surface of the sleeve main body 91 under a state in which the sleeve main body 91 is threadably inserted in the recessed portion 12 through engagement between the male thread portion 101 and the female thread portion 102. The sleeve main body 91 is threadably inserted in the recessed portion 12 to be fitted into the recessed portion 12 by sliding the sleeve 9 in the axis-line direction of the step shaft 8 with respect to the main shaft portion 81 while turning the sleeve 9 in the circumferential direction of the step shaft 8 with respect to the main shaft portion 81. The remaining configuration is the same as that of the first embodiment.

In the step 2 for an escalator described above, the male thread portion 101 is formed on the outer peripheral surface of the sleeve main body 91, whereas the female thread portion 102 to be fitted to the male thread portion 101 is formed in the inner peripheral surface of the recessed portion 12. Therefore, the sleeve 9 can be threadably inserted in the mounting portion 11 to be fixed thereto. In this manner, a backlash of the mounting portion 11 with respect to the sleeve main body 91 can be suppressed. Hence, generation of abnormal noise from the step 2 can also be suppressed.

Further, in each of the embodiments, the present invention is applied to the step 2 for an escalator, but may be applied to step for a moving walkway serving as a passenger conveyor.

### REFERENCE SIGNS LIST

2 step, 8 step shaft, 9 sleeve, 10 step main body, 11 mounting portion, 12 recessed portion, 12a open portion, 21 collar, 211 collar main body, 212 collar projecting portion, 213 protrusion, 81 main shaft portion, 82 projecting shaft portion, 83 first level-difference portion, 91 sleeve main body, 92 claw, 92a engaging surface, 93 connecting portion, 931 arm portion, 933 positioning groove (recessed portion)

1.-6. (canceled)

7. A step for a passenger conveyor, comprising:
a step shaft;
a sleeve provided to the step shaft; and
a step main body provided to the sleeve,
wherein the step shaft includes a main shaft portion and a projecting shaft portion, which has an outer diameter smaller than an outer diameter of the main shaft portion and projects from an end portion of the main shaft portion,
wherein the sleeve includes:
a sleeve main body, which has a cylindrical shape and is slidable with respect to the main shaft portion along an axis line of the step shaft;
a claw to be hooked to a level-difference portion formed at a boundary between the main shaft portion and the projecting shaft portion; and
a connecting portion configured to connect the sleeve main body and the claw,
wherein a mounting portion is fixed to the step main body, the mounting portion having a recessed portion formed therein,
wherein the recessed portion is fitted over an outer peripheral surface of the sleeve main body,
wherein the recessed portion has an open portion smaller than an outer diameter of the sleeve main body, and
wherein the connecting portion includes an arm portion which is elastically deformable in a direction in which the claw is unhooked from the level-difference portion.

8. A step for a passenger conveyor according to claim 7, wherein a radial thickness of the sleeve main body is equal to or larger than a radial thickness of the connecting portion and a radial thickness of the claw.

9. A step for a passenger conveyor according to claim 7, wherein the projecting shaft portion fulfills a function of a chain shaft of a step chain.

10. A step for a passenger conveyor according to claim 8, wherein the projecting shaft portion fulfills a function of a chain shaft of a step chain.

11. A step for a passenger conveyor according to claim 7, wherein, under a state in which the claw is hooked to the level-difference portion, the claw has an engaging surface for the level-difference portion, which is inclined with respect to the axis line of the step shaft, and a distance between the engaging surface of the claw and an outer peripheral surface of the projecting shaft portion continuously decreases in a direction away from the arm portion.

12. A step for a passenger conveyor according to claim 8, wherein, under a state in which the claw is hooked to the level-difference portion, the claw has an engaging surface for the level-difference portion, which is inclined with respect to the axis line of the step shaft, and a distance between the engaging surface of the claw and an outer peripheral surface of the projecting shaft portion continuously decreases in a direction away from the arm portion.

13. A step for a passenger conveyor according to claim 9, wherein, under a state in which the claw is hooked to the level-difference portion, the claw has an engaging surface for the level-difference portion, which is inclined with respect to the axis line of the step shaft, and a distance between the engaging surface of the claw and an outer peripheral surface of the projecting shaft portion continuously decreases in a direction away from the arm portion.

14. A step for a passenger conveyor according to claim 10, wherein, under a state in which the claw is hooked to the level-difference portion, the claw has an engaging surface for the level-difference portion, which is inclined with respect to the axis line of the step shaft, and a distance between the engaging surface of the claw and an outer peripheral surface of the projecting shaft portion continuously decreases in a direction away from the arm portion.

15. A step for a passenger conveyor according to claim 7, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

16. A step for a passenger conveyor according to claim 8, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

17. A step for a passenger conveyor according to claim 9, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

18. A step for a passenger conveyor according to claim 10, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

19. A step for a passenger conveyor according to claim 11, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

20. A step for a passenger conveyor according to claim 12, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

21. A step for a passenger conveyor according to claim 13, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

22. A step for a passenger conveyor according to claim 14, further comprising a collar configured to surround the main shaft portion and the connecting portion in a collective manner,
wherein the connecting portion has a recessed portion formed in an outer peripheral surface thereof,
wherein the collar includes a collar main body having a tubular shape, a collar projecting portion, which projects from the collar main body along the connecting portion and is elastically deformable in a radial direction of the collar, and a protrusion formed on an inner peripheral surface of the collar projecting portion,
wherein the collar is slidable over the outer peripheral surface of the connecting portion between a retaining position at which the arm portion is retained by the collar main body and a release position at which the collar main body is moved from the arm portion to release the retention of the arm portion, and
wherein the protrusion is fitted in the recessed portion when the collar is located at the retaining position.

23. A method of assembling a step for a passenger conveyor of claim 7, the method comprising:
a sleeve mounting step of fitting the sleeve over the main shaft portion of the step shaft while elastically deforming the arm portions radially outward;
a step-main-body arranging step of inserting the main shaft portion through the open portion of the recessed portion in the recessed portion to maintain a position of the step main body under a state in which the main shaft portion is inserted in the recessed portion; and
a step-main-body mounting step of sliding the sleeve in an axis-line direction of the step shaft with respect to the main shaft portion under a state in which the main shaft portion is inserted in the recessed portion to fit the sleeve main body in the recessed portion and hook the claw to the level-difference portion.
